(19) United States
(12) Patent Application Publication
(10) Pub. No.: US 2017/0364148 A1
(43) Pub. Date: Dec. 21, 2017

(54) CONTROL DEVICE FOR VEHICLE AND CONTROL METHOD THEREOF

(71) Applicant: LG ELECTRONICS INC., Seoul (KR)

(72) Inventor: Sangwon KIM, Seoul (KR)

(21) Appl. No.: 15/479,480

(22) Filed: Apr. 5, 2017

(30) Foreign Application Priority Data
Jun. 15, 2016 (KR) 10-2016-0074594

(51) Int. Cl. G06F 3/01; B60K 35/00; G06F 3/14; G01C 21/36

(52) U.S. Cl. CPC G06F 3/013; G06F 3/1462; B60K 35/00; B60K 2350/901; B60K 2350/352; B60K 2350/1056; B60K 2350/96; G01C 21/3667; B60K 2350/92

(57) ABSTRACT

A control device for a vehicle includes a plurality of displays having a first display that is configured to provide vehicle information to a driver of the vehicle, where the vehicle information includes speed information of the vehicle, a sensor configured to obtain eye tracking information of the driver, where the eye tracking information includes a gaze of the driver, and a controller. The controller is configured to determine, based on the eye tracking information, a second display of the plurality of displays to which the gaze of the driver is directed, select a first content to be displayed on the first display, where the first content is based on a gazed second content of the second display, and provide the first content to the first display to be displayed.

### CROSS-REFERENCE TO RELATED APPLICATION

Pursuant to 35 U.S.C. §119(a), this application claims the benefit of an earlier filing date of and the right of priority to Korean Application No. 10-2016-0074594, filed on Jun. 15, 2016, the contents of which are incorporated by reference herein in its entirety.

### BACKGROUND

This specification relates to a control device for a vehicle equipped in the vehicle, and a control method thereof.

A vehicle is an apparatus capable of carrying or moving people or loads using kinetic energy, and a representative example may be a car.

For safety and convenience of a user, various technologies have been developed. In particular, to support these technologies, various sensors and various types of displays are equipped in the vehicle

### SUMMARY

According to one aspect, a control device for a vehicle includes a plurality of displays including a first display that is configured to provide vehicle information to a driver of the vehicle, the vehicle information including speed information of the vehicle, a sensor configured to obtain eye tracking information of the driver, the eye tracking information including a gaze of the driver, and a controller configured to determine, based on the eye tracking information, a second display of the plurality of displays to which the gaze of the driver is directed, select a first content to be displayed on the first display, the first content being based on a gazed second content of the second display, and provide the first content to the first display to be displayed.

Implementations according to this aspect may include one or more of the following features. For example, the gazed second content may include a first visual graphic that is associated with an application, and the controller may be configured to, based on determining that gaze of the driver is directed at the second display, display a second visual graphic that is associated with the application on the first display. In some cases, the controller may be configured to obtain size information of a preset display area of the first display on which the second visual graphic is displayed, adjust, based on the size information of the preset display area of the first display, a size of the second visual graphic, and provide the adjusted first visual graphic to the first display to be displayed on the preset display area. The first visual graphic of the second display may include a first object, the second visual graphic of the first display may include a second object corresponding to the first object, and a size of the first object may be different from a size of the second object. The controller may be configured to adjust a size of the vehicle information that is displayed on the first display based on the size of the second visual graphic that is displayed on the first display. The application may be a navigation application, the first visual graphic of the second display may include a first map image, and the second visual graphic of the first display may be a second map image that is at a different map scale than the first map image.

In some implementations, the controller may be configured to determine whether the gazed second content satisfies a preset condition, and to provide, based on the determination that the gazed second content satisfies the preset condition, the first content that is based on the gazed second content to the first display. The controller may be configured to, based on the determination that the gazed second content does not satisfy the preset condition, provide notification information to at least one of the first display or the second display notifying the driver that the gazed second content is not allowed to be displayed on the first display. In some cases, the controller may be configured to determine, based on the eye tracking information of the driver, a partial content among a plurality of contents on the second display to which the gaze of the driver is directed, wherein the first content provided to the first display corresponds to the gazed partial content. The controller may be configured to determine whether a gaze movement of the tracked eye satisfies a threshold condition, and to provide to the first display the first content corresponding to the gazed partial content based on the determination that the threshold condition has been satisfied. In some cases, the gazed second content may include a primary graphic object that is linked with a preset control function, and the first content provided to the first display may be a secondary graphic object that is associated with the primary graphic object, both the primary graphic object and the secondary graphic object being linked with the preset control function.

In some cases, the controller may be configured to determine whether a time duration that the first content has been displayed on the first display satisfies a threshold time, and to stop displaying, based on the determination that the time duration satisfies the threshold time, the first content to the first display. The controller may be configured to determine, based on the eye tracking information, whether a number of times that a gaze of the driver has been directed to the first content on the first display satisfies a threshold condition, and to continue displaying the first content to the first display based on the determination that the time duration that the first content has been displayed on the first display satisfies the threshold time and the determination that the number of times that the gaze of the driver has been directed to the first display satisfies the threshold condition. In some cases, the controller may be configured to determine, based on the eye tracking information, whether a gaze of the driver has been maintained for a threshold time on the first display, and to provide, based on the determination that the gaze of the driver has been maintained for the threshold time on the first display, speed limit information of a region where the vehicle is located to be displayed on the first display.

In some implementations, the controller may be configured to provide to be displayed on the first display a plurality of contents to which a gaze of the driver has been directed, the plurality of contents being listed according to an order in which the gaze of the driver was directed to each of the plurality of contents. The controller may be configured to, based on determining that the gaze of the driver is directed to a third display of the plurality of displays, update the first content to be based on a gazed third content of the third display, and to provide the updated first content to the first display to be displayed. The controller may be configured to determine whether the vehicle is moving, and to provide, based on the determination that the vehicle is moving, the first content to be displayed on the first display. In some cases, the first display may be a dashboard display.

According to another aspect, a control device for a vehicle includes a first display that is configured to provide vehicle information to a user inside the vehicle, the vehicle information including speed information of the vehicle, a sensor configured to obtain eye tracking information of the user inside the vehicle, the eye tracking information including a gaze of the user, and a controller configured to determine, based on the eye tracking information, a target object to which the gaze of the user is directed, select a first content based on the gazed target object, and provide the first content on the first display.

Implementations according to this aspect may include one or more of the following features. For example, the first display may be a dashboard display, the target object may be a second display that is separate from the first display, and the controller may be configured to generate the first content based on a second content that is displayed on the second display to be displayed.

This specification describes technologies for a control device to control multiple displays for a vehicle

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example control device for a vehicle.

FIG. 2 is a diagram illustrating example displays provided in a vehicle.

FIG. 3 is a flowchart illustrating an example control method of a control device for a vehicle.

FIGS. 4 to 6 are diagrams illustrating an example control device controlled by the control method of FIG. 3.

FIG. 7 is a flowchart illustrating an example control method of a control device for a vehicle.

FIGS. 8A and 8B are diagrams illustrating an example control device controlled by the control method of FIG. 7.

FIG. 9 is a flowchart illustrating an example control method of a control device for a vehicle.

FIGS. 10A to 10D are diagrams illustrating an example control device controlled by the control method of FIG. 9.

FIG. 11 is a diagram illustrating an example control device providing multiple contents as a list.

FIGS. 12A and 12B are diagram illustrating an example control device for a vehicle.

FIG. 13 is a diagram illustrating an example control device for a vehicle.

FIG. 14 is a diagram illustrating an example control device for a vehicle.

FIGS. 15A to 15D are diagram illustrating an example control device for a vehicle.

Like reference numbers and designations in the various drawings indicate like elements.

### DETAILED DESCRIPTION OF THE INVENTION

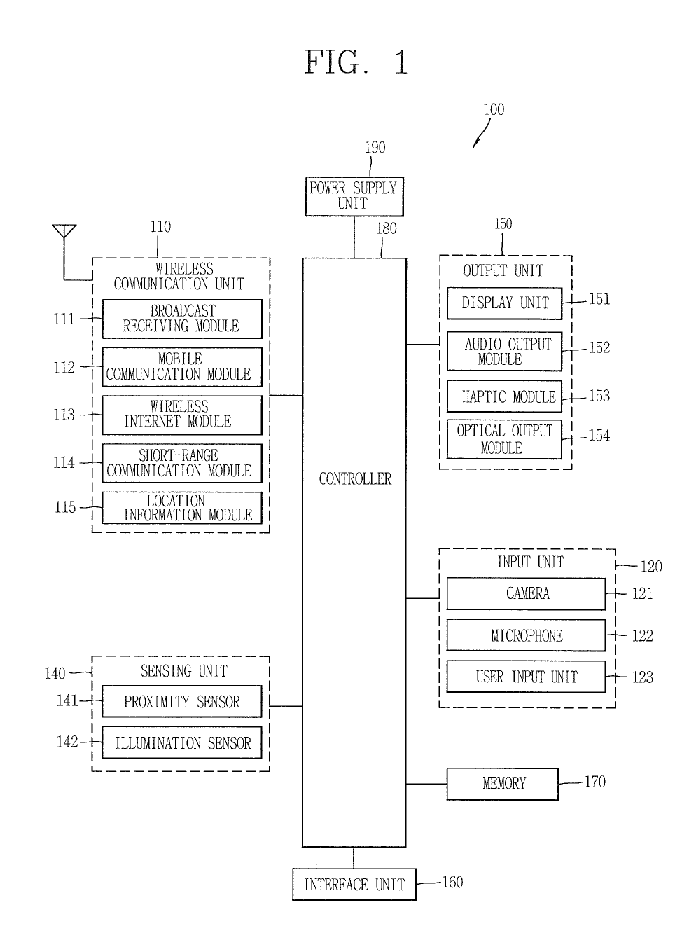

FIG. 1 illustrates an example control device for a vehicle.

A control device 100 for a vehicle is a device for controlling at least one component provided in the vehicle, for example, may be an electronic control unit (ECU). The control device 100 can include one or more computers.

The control device 100 can be mobile terminals such as cellular phones, smart phones, user equipment, laptop computers, digital broadcast terminals, personal digital assistants (PDAs), portable multimedia players (PMPs), navigators, slate PCs, tablet PCs, ultra books, and wearable devices. In addition, the control device 100 can be stationary terminals such as digital TV, desktop computers, and digital signage.

The control device 100 for a vehicle may include a wireless communication unit 110, an Audio/Video (A/V) input unit 120, a sensing unit 140, an output unit 150, an interface unit 160, a memory 170, a controller 180, a power supply unit 190, and the like. However, all of the elements as illustrated in FIG. 1 are not necessarily required, and the mobile terminal may be implemented with greater or less number of elements than those illustrated elements.

In more detail, the wireless communication unit 110 of the components may typically include one or more modules which permit wireless communications between the control device 100 for the vehicle and a wireless communication system, between the control device 100 for the vehicle and another control device for a vehicle, or between the control device 100 and an external server. Also, the wireless communication unit 110 may include at least one module for connecting the control device for the vehicle to at least one network.

The wireless communication unit 110 may include a broadcast receiving module 111, a mobile communication module 112, a wireless internet module 113, a short-range communication module 114, a position location module 115 and the like.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the control device 100, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The control device 100 for the vehicle disclosed herein may be configured to utilize information obtained from at least two sensors of the sensing unit 140, and combinations thereof.

The output unit 150 may generate a visual, audible or tactile output, and may include at least one of the display unit 151, the audio output module 152, the haptic module 153 and an optical output module 154. The display unit 151 may implement a touch screen as being layered or integrated with a touch sensor. The touch screen may function as the user input unit 123 providing a user input interface between the control device 100 for the vehicle and the user and simultaneously providing an output interface between the control device 100 for the vehicle and the user.

The interface unit 160 may serve as a path allowing the control device 100 for the vehicle to interface with various types of external devices connected thereto. The interface unit 160 may include any of wired or wireless ports, external power supply ports, wired or wireless data ports, memory card ports, ports for connecting a device having an identification module, audio input/output (I/O) ports, video I/O ports, earphone ports, and the like. In some cases, the control device 100 for the vehicle may perform assorted control functions associated with a connected external device, in response to the external device being connected to the interface unit 160.

Also, the memory 170 is typically implemented to store data to support various functions or features of the control device 100 for the vehicle. For instance, the memory 170 may be configured to store application programs executed in the control device 100 for the vehicle, data or instructions for operations of the control device 100 for the vehicle, and the like. Some of these application programs may be downloaded from an external server via wireless communication. Other application programs may be installed within the control device 100 for the vehicle at time of manufacturing or shipping, which is typically the case for basic functions of the control device 100 for the vehicle (for example, receiving a call, placing a call, receiving a message, sending a message, and the like). It is common for application programs to be stored in the memory 170, installed in the control device 100 for the vehicle, and executed by the controller 180 to perform an operation (or function) for the control device 100 for the vehicle.

The controller 180 typically functions to control overall operation of the control device 100 for the vehicle, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 controls some or all of the components illustrated in FIG. 1A according to the execution of an application program that have been stored in the memory 170. In addition, the controller 180 may control at least two of those components included in the mobile terminal to activate the application program.

The power supply unit 190 can be configured to receive external power or provide internal power in order to supply appropriate power required for operating elements and components included in the control device 100 for the vehicle. The power supply unit 190 may include a battery, and the battery may be configured to be embedded in the terminal body, or configured to be detachable from the terminal body.

With reference to FIG. 1A, the display unit 151 is generally configured to output information processed in the control device 100 for the vehicle. For example, the display unit 151 may display execution screen information of an application program executing at the control device 100 for the vehicle or user interface (UI) and graphic user interface (GUI) information in response to the execution screen information.

As another example, the display unit 151 may output vehicle-related information. Here, the vehicle-related information may include vehicle control information for a direct control of the vehicle, or a vehicle driving assist information for providing a driving guide to a driver. Also, the vehicle-related information may include vehicle state information notifying a current state of the vehicle, or vehicle driving information related to driving of the vehicle.

The display unit 151 may include at least one of a liquid crystal display (LCD), a thin film transistor-liquid crystal display (TFT-LCD), an organic light emitting diode (OLED), a flexible display, a 3-dimensional (3D) display, an e-ink display, and combinations thereof.

Also, the display unit 151 may be implemented using two or more display devices according to an implemented shape of the control device 100 for the vehicle. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit such that a user can input a control command in a touching manner.

In particular, the display unit 151 may include a display and a touch sensor, and the touch sensor and the display may organically operate under the control of the controller. For example, when a touch is applied to the display unit 151, the touch sensor may detect the touch and the controller 180 may generate a control command corresponding to the touch based on it. The controller 180 may detect a touch applied to the touch sensor even in a power-off state of the display and perform a control corresponding to the detected touch. Contents input by the touching method may be characters, numbers, instructions in various modes, or menu items to be designated.

In this manner, the display unit 151 may form a touch screen together with the touch sensor, and in this example, the touch screen may function as the user input unit 123 (see FIG. 1A).

In some implementations, the display unit 151 may include a cluster which allows the driver to check vehicle status information or vehicle driving information as soon as driving the vehicle. The cluster may be located on a dashboard. In this example, the driver may check information output on the cluster while viewing the front of the vehicle.

In some implementations, the display unit 151 may be implemented as a head up display (HUD). When the display unit 151 is implemented as the HUD, information may be output through a transparent display provided on a windshield. Or, the display unit 151 may be provided with a projection module and thus output information through an image projected on the windshield.

In some implementations, the display unit 151 may include a transparent display. In this example, the transparent display may be attached to the windshield.

The transparent display may have predetermined transparency and output a predetermined screen. To have the transparency, the transparent display may include at least one of a transparent thin film electroluminescent (TFEL) display, a transparent OLED display, a transparent LCD display, a transmittive transparent display, and a transparent LED display. The transparency of the transparent display may be adjustable.

At least some of the aforementioned components may be operable to implement operations, controls or control methods of the control device 100 for the vehicle. Also, the operation, control or control method of the control device 100 for the vehicle may be implemented on the vehicle control device 100 by executing at least one application program stored in the memory 170.

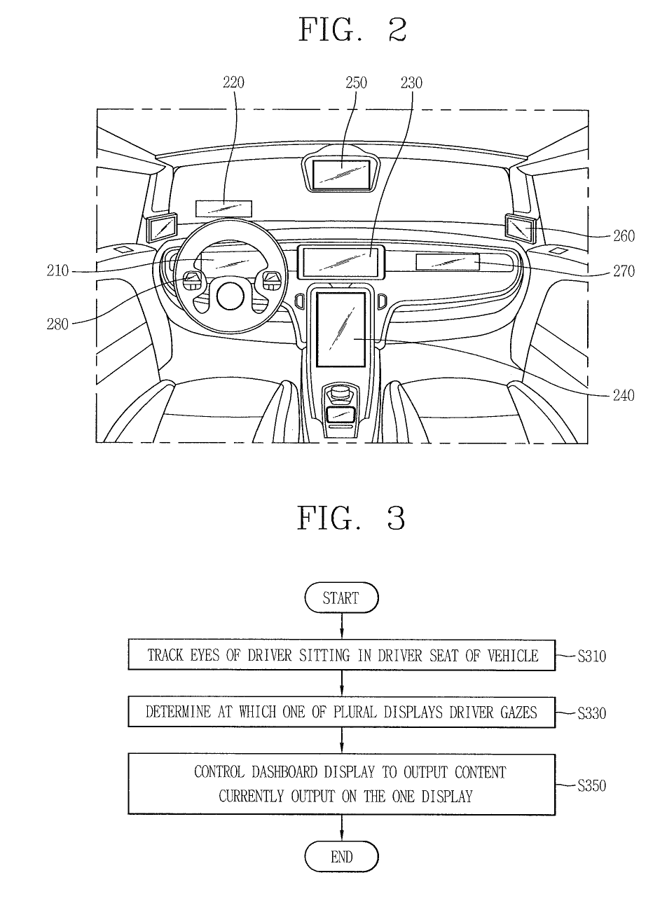

FIG. 2 illustrates example displays provided in a vehicle.

As illustrated in FIG. 2, various types of displays are disposed within a vehicle to support and enhance functions of the vehicle.

The multiple displays are located at different positions, and output different types of information depending on such positions. That is, the plurality of displays may be classified into different types according to their installed positions.

For example, the plurality of displays may include a dashboard display 210, a head up display (HUD) 220, a center information display (CID) 230, a center fascia display 240, a back mirror display 250, a side mirror display 260, a passenger seat display 270 and a steering wheel display 280. In some cases, the dashboard display and the head up display may be implemented as a single unit.

The dashboard display 210 is a display for providing a driver with a driving state of the vehicle and information related to an operation of each device provided in the vehicle, such that the driver can safely drive the vehicle. The dashboard display 210 is located at the rear of a steering wheel based on a driver seat. A speedometer informing of a driving speed, a trip meter informing of a driving distance, a tachometer informing of revolutions per minute (RPM) of an engine, a fuel meter, a water temperature gauge, an engine temperature gauge and various warning lamps are output through the dashboard display 210.

The head up display (HUD) 220 is a display projecting a virtual image on a windshield of the vehicle, and provides a speed of the vehicle, a remaining fuel level, road guide information and the like so as to prevent an unnecessary movement of a driver's gaze to other portions.

Displays that are located between a driver seat and a passenger seat on the dashboard of the vehicle may be referred to as the center information display (CID) 230 and/or the center fascia display 240.

When one of the center information display 230 and the center fascia display 240 is provided in the vehicle, the one display may output a map image guiding a path up to a destination or corresponding to a current position, or output user interfaces associated with controls of various devices equipped in the vehicle. In addition, when the vehicle and a mobile terminal are connected to each other, the one display may output a screen provided from the mobile terminal.

When both of the center information display 230 and the center fascia display 240 are provided in the vehicle, the center fascia display 240 is located below the center information display 230. In this example, the center information display 230 outputs the map image and the center fascia information 240 outputs the user interfaces associated with the controls of the various devices equipped in the vehicle. That is, the driver can check the path using the center information display 230 and input control commands associated with a temperature adjustment, a wind adjustment, an audio and the like within the vehicle using the center fascia display 240.

The back mirror display 250 is a display performing a function of a back mirror. The back mirror display 250 outputs an image captured by a camera provided to face the rear of the vehicle.

Here, a direction that the driver naturally gazes when seating in the driver seat is defined as a forward direction, and a direction opposite to the direction that the driver gazes is defined as a backward direction.

The side mirror display 260 refers to a display performing a function of a side mirror. The side mirror display 260 is similar to the back mirror display 250 in view of outputting an image captured by a camera which is disposed to face the rear side of the vehicle, but provides an image with a different view from that provided on the back mirror display 250.

In particular, since the side mirror display 260 is provided on each side surface of the vehicle and outputs an image captured by a camera facing the rear side of the vehicle, at least part of the side surface may be included in the image output on the side mirror display 260. On the other hand, an image output on the back mirror display 250 does not include the side surface of the vehicle. Here, the side surface of the vehicle refers to a surface with a door.

The passenger seat display 270 is located at the front of a passenger sitting in the passenger seat. The passenger seat display 270 is provided for the passenger sitting in the passenger seat, not for the driver, and thus may output thereon a video irrespective of whether or not the vehicle is moving.

The steering wheel display 280 is located on a steering wheel, and allows the driver to control a moving direction of the vehicle using the steering wheel and facilitates the driver to apply a user input. For example, when a volume adjustment function is executed, the steering wheel display 280 outputs a volume-up object and a volume-down object. The driver can adjust the volume using those objects output on the steering wheel display 280.

As aforementioned, with the installation of the plurality of displays in the vehicle, the driver can be provided with convenient functions and useful information, but fails to concentrate on traffic conditions which change in real time at the front of the vehicle. Hereinafter, the present invention to solve such problems will be described in particular.

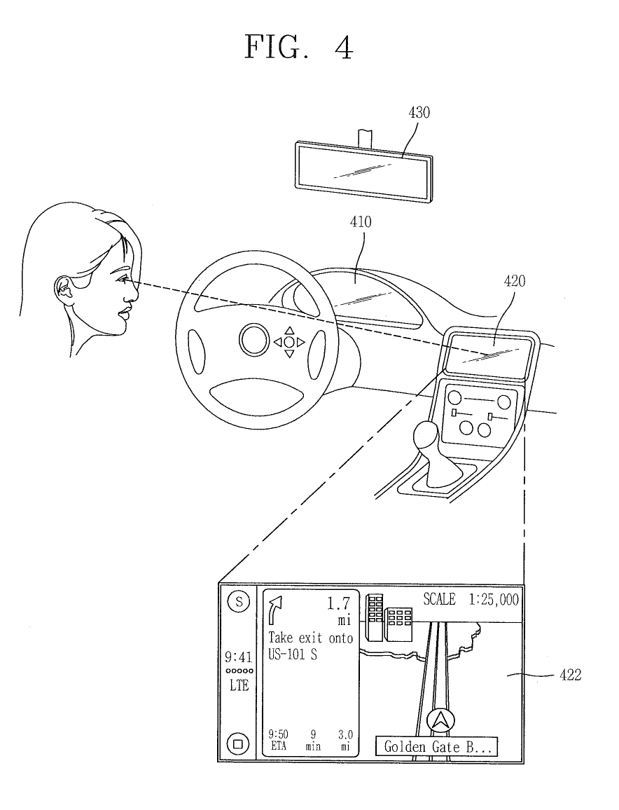

FIG. 3 illustrates a flowchart of an example control method of a control device. FIGS. 4 to 6 illustrate an example control device for a vehicle controlled by the control method of FIG. 3.

First, the controller tracks eyes (gaze) of a driver sitting in a driver seat of a vehicle (S310). In particular, when an engine of the vehicle is started, the controller activates an eye tracking for the driver and calculates eye positions in real time.

The eye tracking is a technology of tracking eyes by sensing a movement of each pupil, and includes a video analyzing type, a contact lens type, a sensor attachment type and the like.

The video analyzing type eye tracking detects movements of the pupils through an analysis of an image captured by a camera, and calculates the driver's gaze based on the detected movements. The contact lens type eye tracking calculates a driver's gaze using light reflected of a mirror-embedded contact lens or a magnetic field of a coil-embedded contact lens. The sensor attachment type detects changes in an electric field according to movements of eyes by attaching sensors around the driver's eyes, and calculates the driver's gaze based on the sensed changes.

The vehicle and/or the control device for the vehicle are provided with sensors tracking eyes of a driver sitting in the driver seat of the vehicle. The sensors may track the driver's eyes and transmit the tracked results to the controller, or the controller may track the driver's eyes using information received from the sensors.

Next, the controller determines at which object, for example the plurality of displays provided in the vehicle, the driver gazes (S330).

The controller may detect a specific object which the driver looks at on the basis of the tracked driver's gaze.

When the driver gazes in the vehicle, which object in the vehicle the driver is looking at may be detected. In particular, the controller may extract a specific object which the user is looking at using a two-dimensional (2D) and/or three-dimensional (3D) coordinate system stored in the memory. For example, when a volume adjustment device is located within a predetermined coordinates range and the driver's gaze is located within the predetermined range, the controller may determine that the driver is looking at the volume adjustment device.

Even when the driver is looking out of the windshield of the vehicle, the controller may detect which object outside the vehicle the driver is looking at. For example, the controller may calculate a position of the driver's gaze using a coordinate system stored in the memory, and search for an object which is located at the calculated gaze position. In this example, the controller may search for the object located at the gaze position using a sensor, such as a camera facing outside of the vehicle, a radar, a LiDar and the like, and search for information related to a distance between the vehicle and the searched object, and size, color, speed, type and the like of the object.

The controller may select one of the plurality of displays provided in the vehicle on the basis of the gaze when the driver gazes in the vehicle. That is, one display which the driver is currently looking at is selected from the plurality of displays outputting various types of information.

Next, the controller controls the dashboard display 210 to output a content which is currently output on the selected one display (S350).

In general, the dashboard display 210 outputs speed information regarding the vehicle. In addition, the dashboard display 210 outputs various types of information that the driver has to be provided.

The driver should check information output on the dashboard display while fixing the eyes on external environments of the windshield, and thus the dashboard display is located within a range of the gaze directed at the windshield. Two eyes of human being are spaced apart from each other in left and right directions. Therefore, a field of view of the human being is wider in the left and right directions than in up and down directions. Thus, the dashboard 210 is located below the windshield.

However, due to limitation by law, types of information which can be output on the dashboard 210 are limited.

When the HUD 220 is provided, the driver can be provided with information on the HUD 220 while looking forward, but an amount of information which can be provided to the driver through the HUD 220 is limited due to a characteristic of an output method of projecting a virtual image on the windshield.

The driver is provided with information, which cannot be output on the dashboard display 210 and/or the HUD 220, using other displays 230 to 280. Therefore, the other displays are risk factors that disturb the driver's driving.

To remove such risk factors, the controller copies a content that is currently output on a specific display 230 to 280 that the driver is gazing, and outputs the copied content on the dashboard display 210.

In more detail, when the driver gazes at a specific display for longer than a reference time, a content currently output on the specific display is copied and the copied content is output on the dashboard display 210. When the driver gazes at the specific display for shorter than a reference time, the content currently output on the specific display is not output on the dashboard display 210. This is to prevent information unnecessary to the driver from being copied and output on the dashboard display 210.

Here, the content is defined as various information or details of such information provided through displays. The content may include at least one of a character, a symbol, an image and a video.

Copying the content includes not only copying an original content into an original size or in an enlarging/reducing manner, but also reconstructing the content into information having substantially the same details.

A content which is currently output on a display that the driver is currently looking at is referred to as ‘original content’ and a content which is copied and output on the dashboard display 210 is referred to as ‘copied content.’

The original content and the copied content may have the same type and shape, or different types and shapes. Even though the original content and the copied content have different types and shapes, the driver can be provided with information, which has substantially the same details as the original content, through the copied content.

In some implementations, the dashboard display 210 may output thereon essential information that should be output, and selectable information which is selectively output. For example, speed information guiding the speed of the vehicle is included in the essential information that should be output on the dashboard display 210. On the other hand, an available driving distance based on an amount of fuel fed, an instant fuel ratio and an average fuel ratio may be included in the selective information which does not need to be output.

The essential information and the selective information may differ according to a country in which the vehicle is driven and/or a country in which the vehicle is registered.

When the copied content with respect to the original content which was output on another display is output on the dashboard display 210, the essential information may continuously be output and the selective information may disappear from the dashboard display 210. In this example, the selective information may be replaced with the copied content.

In some implementations, an execution screen of an application can be displayed on a display. The execution screen of an application may include a visual graphic including pictures, drawings, diagrams, or texts.

For example, when the driver's gaze is directed at a first display while a first execution screen of a first application is output on the first display, the controller 180 may control the dashboard display 210 to output a second execution screen of the first application. That is, information with substantially the same details, provided from the same application, may be output as the first execution screen on the one display and as the second execution screen on the dashboard display 210. In this example, the dashboard display 210 simultaneously outputs the second execution screen and the essential information.

Here, the application is a conception including a widget or a home launcher, and thus refers to every type of program which can be executed in the vehicle. Therefore, the application may be a program which performs a function, such as an advanced driver assistance system (ADAS), a navigation, a weather, image capturing using cameras provided inside/outside the vehicle, a radio, a web browser, an audio reproduction, a video reproduction, a message transmission and reception, a schedule management, an update of an application, or the like.

For example, as illustrated in FIG. 4, a dashboard display 410 and first and second displays 420 and 430 may be provided in the vehicle. The first display 420 may output a map image corresponding to a current position of the vehicle, and the second display 430 may output a rear image captured by a camera disposed to face the rear of the vehicle.

Although not illustrated, a sensor which tracks the driver's gaze is provided within the vehicle, and the controller may track the driver's gaze using the sensor.

Since a first execution screen 422 of a map application is output on the first display 420, the driver should check the first display 420 for checking his or her driving path.

When the driver's gaze is directed at the first display 420 for a reference time, the controller controls the dashboard display 410 to output a second execution screen of the map application.

In this example, a different operation may be executed according to whether or not a size of essential information is adjustable. In particular, a method of outputting a copied content differs according to whether the dashboard display is a variable display or a fixed display. Here, the variable display refers to a display on which an output area of essential information and an output area of selective information are variable, and the fixed display refers to a display on which a size and position of an output area of essential information is fixed.

Hereinafter, a variable display on which an output area of essential information is variable such that the size of the essential information is adjustable will be described.

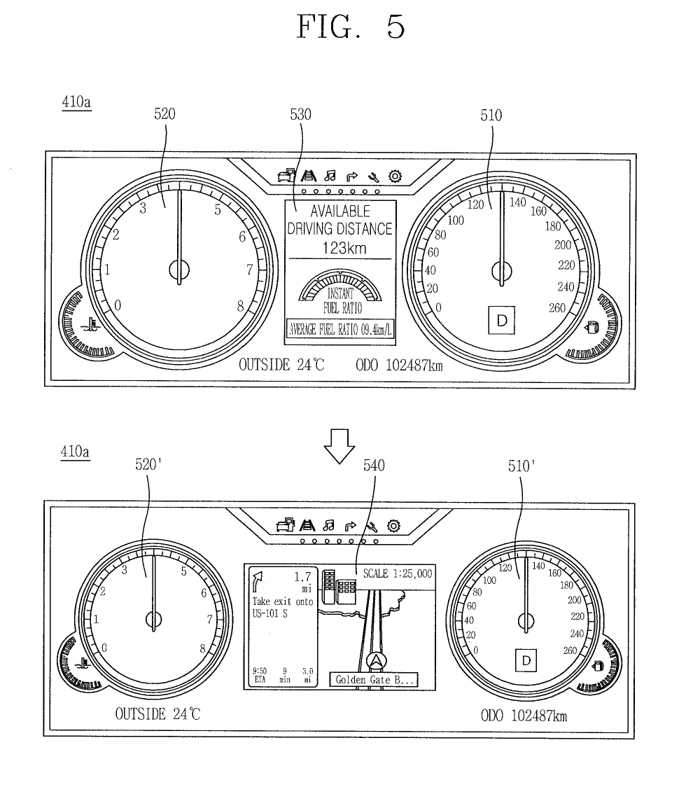

As illustrated in FIG. 5, a dashboard display 410a may output a speedometer 510 and a trip meter 520 both corresponding to essential information, and an available driving distance, an instant fuel ratio and an average fuel ratio corresponding to selective information 530.

in some implementations, types of the essential information and the selective information may be different. In particular, the type of information included in the essential information may depend on a vehicle, a country in which a vehicle is currently moving, and a country in which a vehicle is registered. For example, when the vehicle is an electric vehicle, the trip meter 520 may be included in selective information, other than essential information.

When the driver gazes at a first execution screen 422 of a first application currently output on a first display 420 for a reference time, the controller outputs a second execution screen 540 of the first application on the dashboard display 410a. In this example, the controller may adjust a size of essential information on the basis of a size of the second execution screen 540.

The second execution screen 540 is output on the dashboard display 410a, instead of the selective information 530. When the size of the second execution screen 540 is greater than the size of the selective information 530, the essential information may be resized down according to the size of the second execution screen 540. For example, the visual graphic 510 can be resized to the visual graphic 510′ and the visual graphic 520 can be resized to the visual graphic 520′. On the other hand, when the size of the second execution screen 540 is smaller than the size of the selective information 530, the essential information may be resized up according to the size of the second execution screen 540.

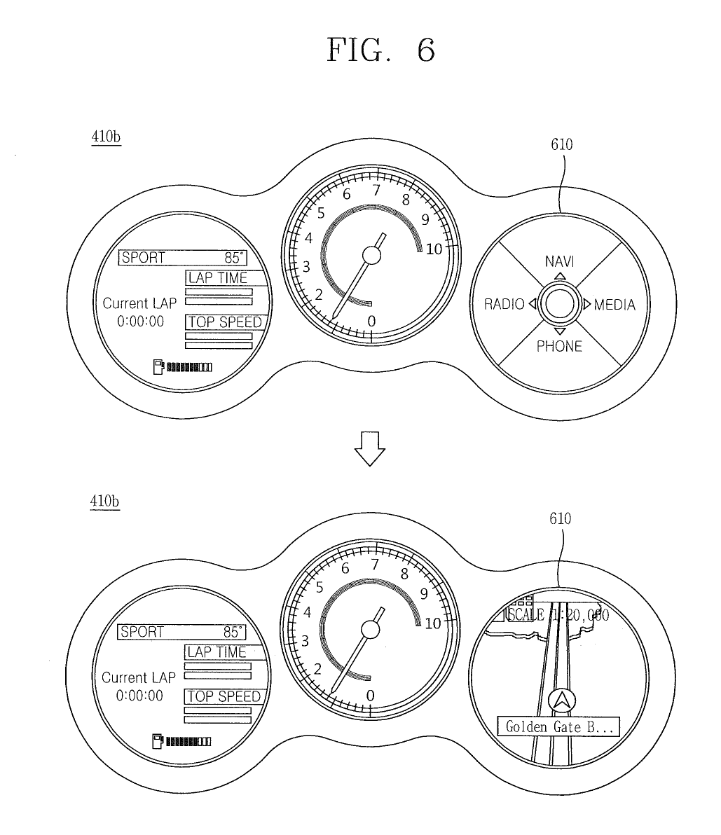

On the contrary, as illustrated in FIG. 6, a dashboard display 410b may be a fixed display on which an output area of essential information is fixed such that the size of the essential information cannot be resized.

In this example, the controller may control the dashboard display 410b to output the second execution screen on a preset area 610 of the dashboard display 410b, and adjust at least one of size and shape of the second execution screen on the basis of the preset area 610. Referring to FIG. 6, the preset area 610 is circular, and thus the second execution screen may be adjusted into a circulate shape and then output.

In some implementations, even for execution screens with respect to the same application, a size of an object included in a first execution screen and a size of an object included in a second execution screen may differ. For example, the object may be text, image, video and the like.

In addition, when the application is a navigation application guiding a path using a map image, a scale applied to the first execution screen and a scale applied to the second execution screen may be different from each other. This is because the size of the first execution screen and the size of the second execution screen are different from each other. For example, the first execution screen may show a map image where 1 cm corresponds to 1 km while the second execution screen may show a map image where 1 cm corresponds to 100 meters.

An original content may be copied as it is, but a copied content may be transformed from the original content according to a size of a dashboard display and essential information to be output. Accordingly, the driver can be provided with a copied content, which is optimized for a driving environment, through the dashboard display.

When an original content is a map image (or a first execution screen of a map application) including a position of the vehicle, details of the original content differ in response to changes in the position of the vehicle. In this example, a copied content of the original content is also a map image (or a second execution screen of the map application), and thus details of the copied content also change in response to the changes in the details of the original content. Accordingly, the driver can check a map image corresponding to a current position through the dashboard display, even without moving the gaze to the first display.

Although not illustrated, while the second execution screen of the first application is output on the dashboard display, the driver's gaze may be directed at the second display 430, different from the first display 420. In this example, the controller may control the dashboard display not to output the second execution screen anymore and to output a copied content with respect to a content currently output on the second display.

For example, when the second display 430 is the back mirror display 250 and the driver gazes at the back mirror display 250 for a reference time, an image captured by a camera disposed to face the rear side of the vehicle may be output on the dashboard display, instead of the map image.

Since information currently output on a specific display can be copied and output on a dashboard display merely in a manner that the driver looks at the specific display, the driver can be provided with interested information through the dashboard display. Since the interested information is output on the dashboard display, the driver can check the interested information while looking forward. Thus, it can be prevented an environment out of the windshield from disappearing from the driver's eyes while the driver checks the interested information.

In some implementations, when the driver's gaze is not directed at the dashboard display for a preset time, starting from a time point that the copied content is started to be output on the dashboard display, the controller terminates the output of the copied content. In other words, the controller controls the dashboard display not to output the copied content anymore and re-output the selective information. If the driver does not look at the dashboard display even when the copied content is output on the dashboard display, it means that the driver does not intend to use the copied content.

In some implementations, information output on a dashboard display is limited by law to prevent interference with the driver's driving. When the driver gazes at information that should not be used, a predetermined limitation is needed.

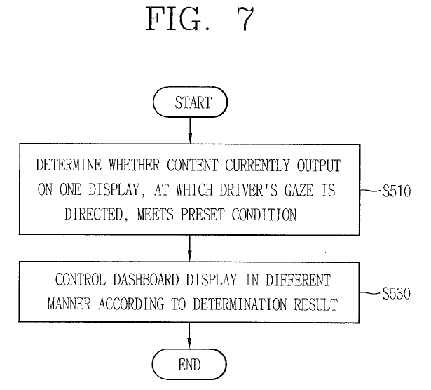

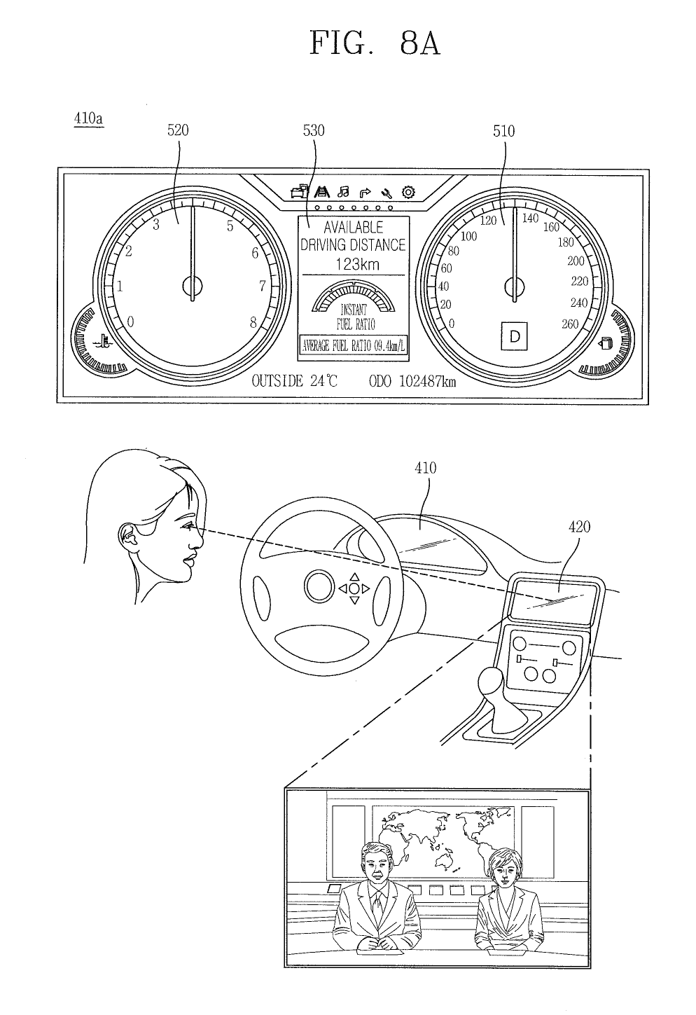

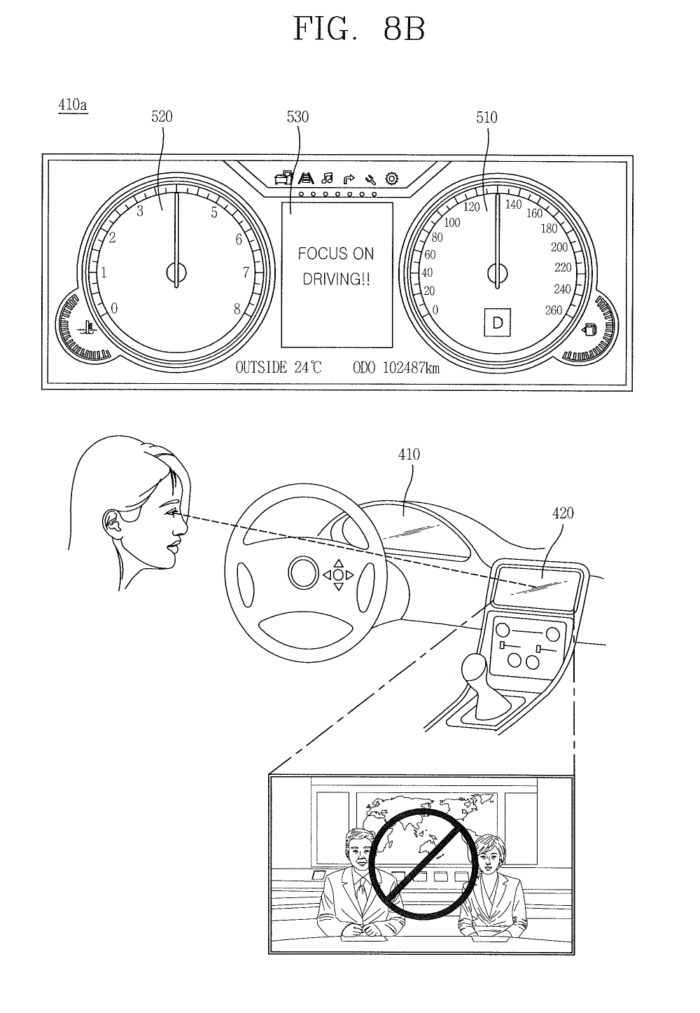

FIG. 7 illustrates an example flowchart of a control method of a control device for a vehicle. FIGS. 8A and 8B illustrate an example control device controlled by the control method of FIG. 7.

The controller may determine whether or not a content currently output on one display meets a preset condition when the driver's gaze is directed at the one display (S710).

Here, the preset condition refers to a criterion for determining whether or not information, which can be used by the driver while the vehicle is driven at a reference speed or more, corresponds to content that is allowable, legally or otherwise.

For example, in many countries including South Korea, while a vehicle is moving, a video should not be output on a position at which the driver can watch the video through a device for receiving or reproducing videos such as broadcast programs while driving. However, a geographic image, an image for providing traffic information, an image for informing an emergency environment, or an image for helping viewing left and right sides or front and rear sides of the vehicle may be output even while the vehicle is moving. Accordingly, when the vehicle is located in South Korea or other countries with similar rules, the controller determines whether or not an image which the driver is looking at corresponds to an image that can be output even while the vehicle is moving. Additionally, or alternatively, content related to the mobile terminal may be completely or partially restricted from being output to the driver while the vehicle is moving.

In some cases, the preset condition may refer to the number of sub-menus that the driver is allowed to select while driving. For example, the driver may be restricted from selecting and viewing, while driving, a menu depth of greater than three levels. The number of menu levels that the driver is allowed select during driving may depend on preset conditions.

The preset condition may be stored in the memory at the moment that the vehicle and/or the control device for the vehicle are produced by a manufacturer or updated through wireless communication.

Next, the controller controls the dashboard display in a different manner according to the determination result (S730).

When an original content currently output on one display which the driver is currently looking at meets a preset condition, the controller controls the dashboard display to output a copied content with respect to the original content.

On the other hand, when the original content does not meet the preset condition, the copied content is restricted from being output on the dashboard display. In this example, the controller may output notification information, which notifies that the original content cannot be output on the dashboard display, on at least one of the dashboard display and the one display.

For example, as illustrated in FIG. 8A, when the driver gazes at a specific display, on which a video of a digital multimedia broadcast (DMB) is currently output, for a reference time, as illustrated in FIG. 8B, the controller stops the output of the video currently output on the specific display and output on the dashboard display a message for guiding that video watching is legally limited during driving. Alternatively, or additionally, the warning message may be displayed on the passenger seat display.

Although not illustrated, when the original content does not meet the preset condition, the controller may limit the output of the copied content on the dashboard display, but store the copied content in the memory. When the original content is a real-time broadcasting video, the controller generates a copied content by recording the original content for a predetermined time, and stores the generated copied content in the memory. The copied content stored in the memory may be output through the dashboard display when the vehicle is stopped.

In some cases, the restricted content may be transferred instead to the passenger seat display. Such transfer may occur, for example, if the driver requested the restricted content while a passenger is present.

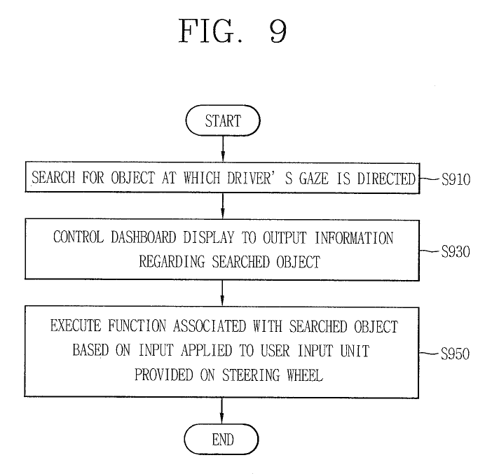

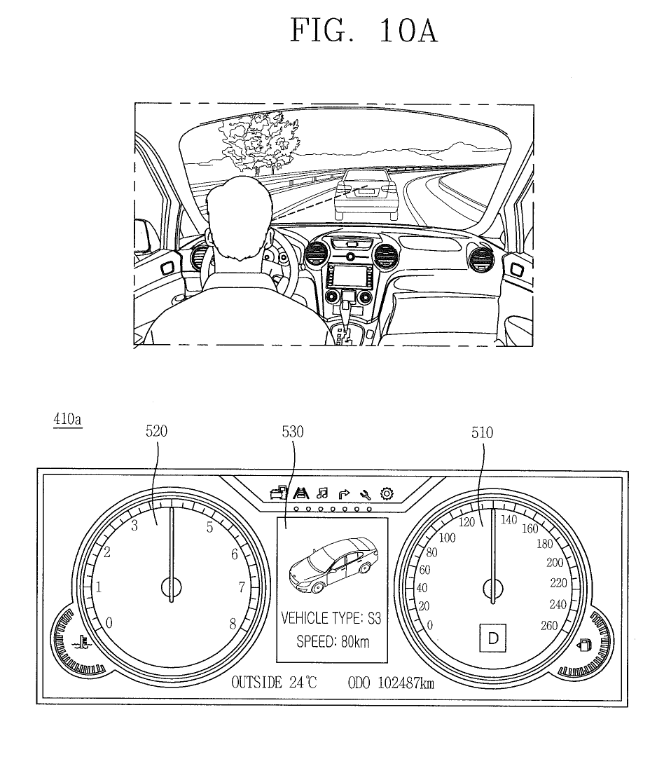

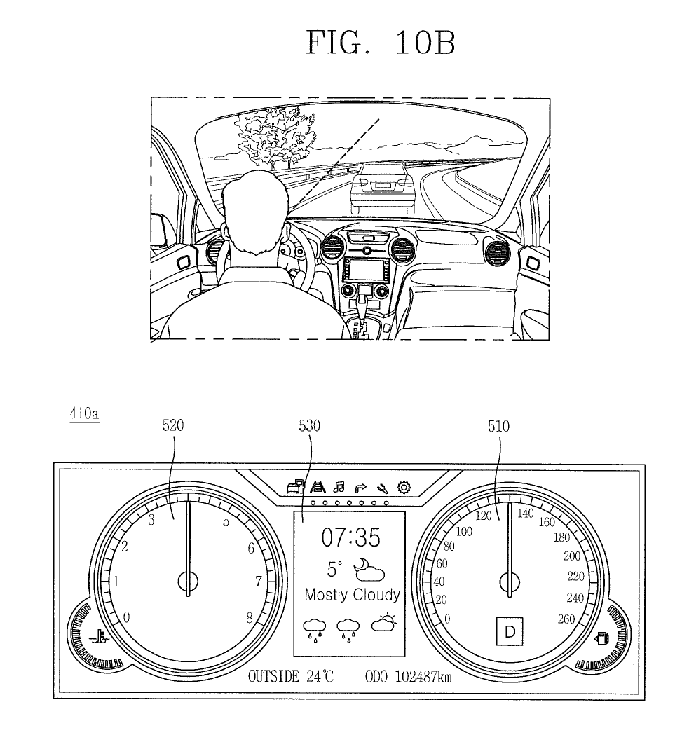

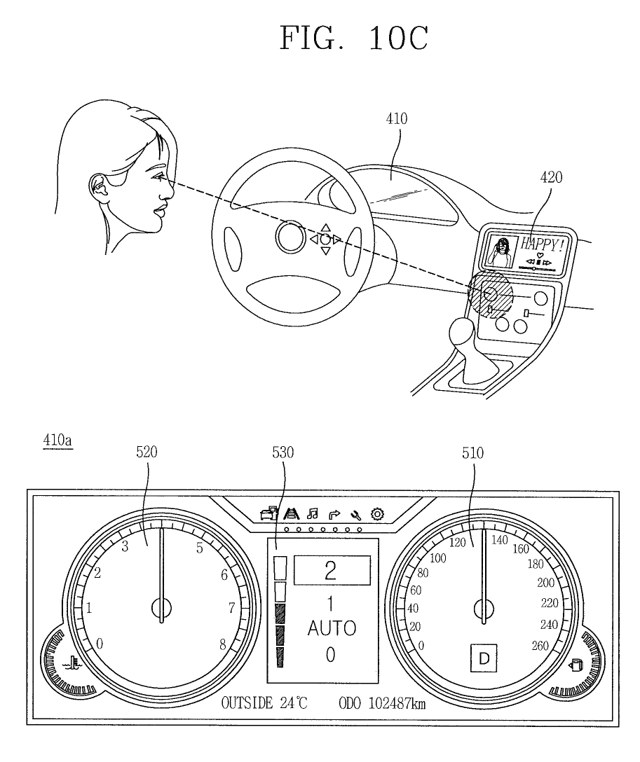

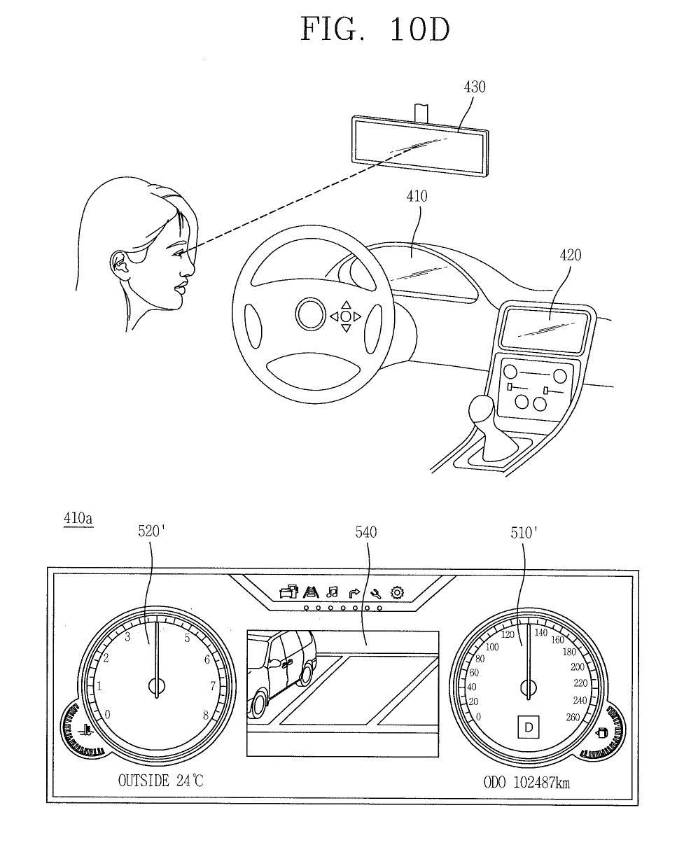

FIG. 9 illustrates an example control method of a control device for a vehicle. In this example, a driver's gaze may be directed to an object, that can be inside or outside the vehicle, rather than just the display. FIGS. 10A to 10D illustrate an example control device controlled by the control method of FIG. 9. In some cases, the object may include physical knobs and buttons, a mobile terminal or a storage location thereof, and etc.

The controller detects an object at which the driver's gaze is directed (S910).

As aforementioned in FIG. 3, when the driver gazes in the vehicle, the controller may detect which object within the vehicle the driver is looking at. Even when the driver looks out of the windshield of the vehicle, the controller may detect which object outside the vehicle the driver is looking at.

Next, the controller controls the dashboard display to output information related to the detected object (S930).

When the driver gazes at an object located outside the vehicle for a reference time, the controller detects the object which the driver gazes at, using at least one sensor provided in the vehicle.

The object includes every type of object, such as a vehicle, a sign, a signboard, a banner and the like, which the driver may see during driving.

The controller may capture the detected object using a camera, and output the captured image or video on the dashboard display as object information regarding the detected object.

For example, as illustrated in FIG. 10A, when the detected object is a vehicle, the object information may further include a speed of the detected object, and a license number written on a license plate of the vehicle.

In addition, the controller may transmit the captured image to a server and include information received from the server in the object information output on the dashboard display. For example, when a captured image of the vehicle is transmitted to the server, the server may search for a type of the vehicle using the image and transmit searched vehicle type information to the control device for the vehicle.

As illustrated in FIG. 10B, when the driver looks up the sky for a reference time, the controller may receive weather information related to a current position from the server, and output the received weather information on the dashboard display.

When the driver's gaze is directed at an electric device equipped in the vehicle, the controller may control the dashboard display to output one or more menus associated with the electric device. For example, as illustrated in FIG. 10C, when the driver gazes at a volume adjustment device for a reference time, the controller controls the dashboard display to output menus associated with the volume adjustment. Similarly, when the driver gazes at HVAC controls for a reference time, the controller may control the dashboard display to output menus associated with the HVAC controls.

A steering wheel of the vehicle may be provided with a user input unit. The controller may execute a function associated with the one or more menus on the basis of a user input applied to the user input unit.

In order for the driver to manipulate the volume adjustment device, one of the driver's hands should be taken away from the steering wheel. However, according to the present application, the driver can adjust the volume using the user input unit provided on the steering wheel while gripping the steering wheel with both hands.

As illustrated in FIG. 10D, when the driver gazes at a back mirror for a reference time, the controller may output an image captured by a rear camera facing the rear of the vehicle on the dashboard display. In this example, when a user input is applied to the user input unit provided on the steering wheel, the controller may adjust a direction that the rear camera faces on the basis of the applied user input.

In some cases, when the driver gazes at a clock provided within the vehicle for a reference time, time information may be output on the dashboard display. When the driver gazes at a window adjustment button of a passenger seat for a reference time, menus for adjusting a height of the window of the passenger seat may be output on the dashboard display.

In this manner, in the manner that the driver merely gazes at a specific object, object information related to the gazed object may be output on the dashboard display and the driver can thus execute a control function associated with the gazed object using the user input unit provided on the steering wheel. This may result in enhancement of the driver's convenience and concentration on driving.

In some cases, when the driver gazes at a mobile terminal for a reference time, the controller may output the received message on a dashboard display. Alternatively, or additionally, control menus for operating the mobile terminal may be output on the dashboard display when the driver's gaze is detected for a reference time. In some implementations, when the driver gazes for a reference time at a pre-determined location within the vehicle where the mobile terminal is designed to be stored or mounted, control menus for operating the mobile terminal as well as other displays related to the mobile terminal may be output on the dashboard display regardless of whether the mobile terminal is actually present in the pre-determined location. For instance, if the mobile terminal is inside the driver's clothing or in another obstructed location, gazing at the pre-determined mobile terminal location may nevertheless bring up the related control menus on the dashboard display.

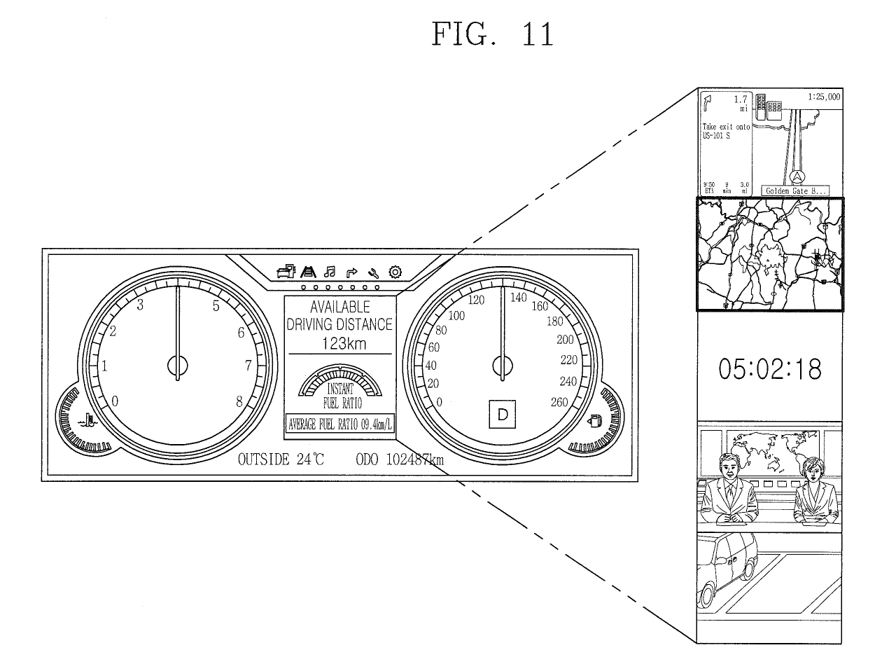

FIG. 11 illustrates an example control device providing multiple contents as a list.

The controller may output a plurality of copied contents in a form of a list according to a gazed sequence. For example, when a second copied content is output while a first copied content is output, the first and second copied contents may be sequentially be output like a list in the order of being gazed, starting from a reference point.

The controller may select one of the plurality of copied contents included in the list based on a user input, and output the selected copied content on the dashboard display in an enlarging manner. In this example, the rest of copied contents except for the selected copied content disappear from the dashboard display.

In some implementations, the controller may control the dashboard display to re-output the list including the copied contents, on the basis of a user input. The driver can select one copied content desiring to use from various copied contents generated in the gazing manner.

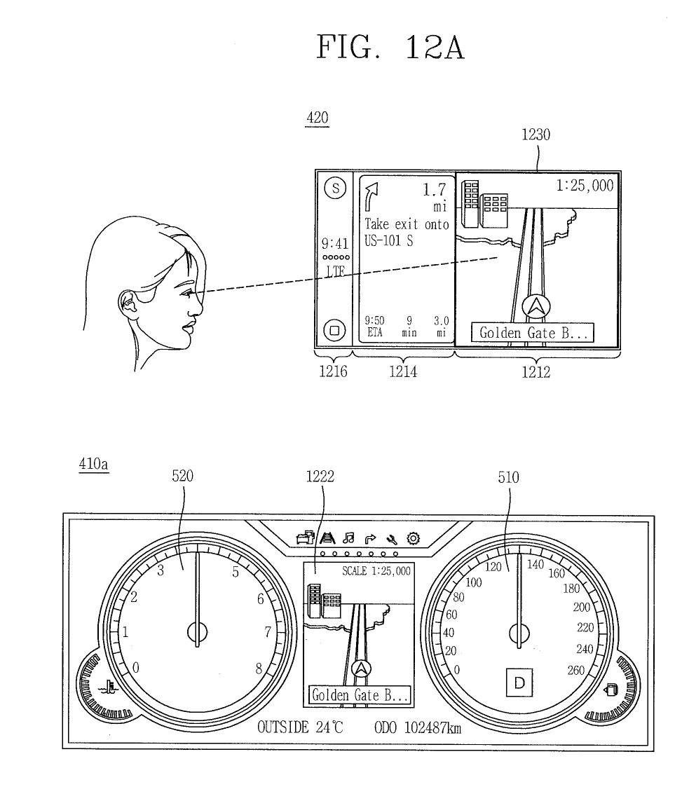

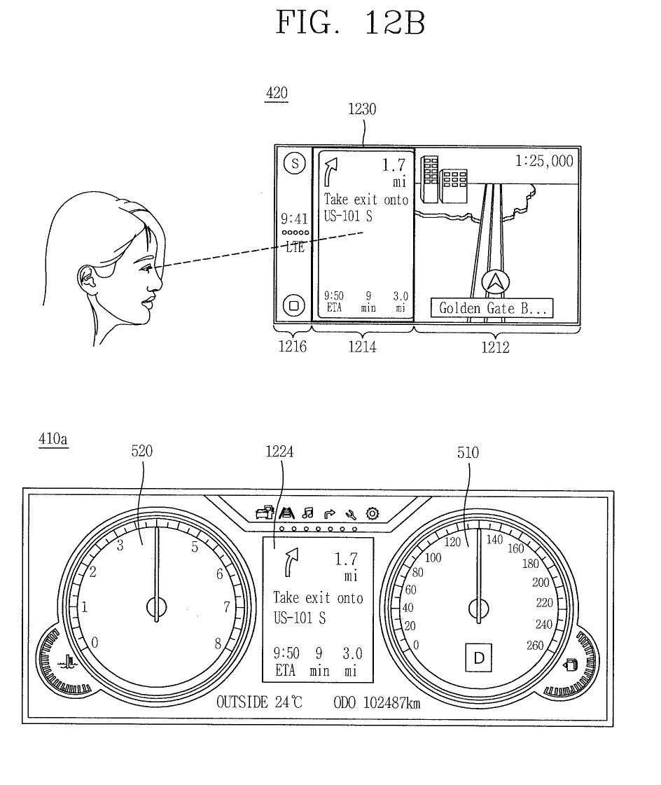

FIGS. 12A and 12B illustrate an example control device for a vehicle.

When the driver gazes at a display for a predetermined time, the controller may select at least part of contents, at which the driver's gaze is currently directed, from a plurality of contents currently output on the one display. In this example, a copied content of the selected at least part content is output on the dashboard display.

For example, as illustrated in FIG. 12A, three dividable contents 1212, 1214 and 1216 may be output on the one display. In this example, the controller may select at least one of the plurality of contents 1212, 1214 and 1216 based on the driver's gaze.

In some cases, when the selection is made by the driver, the selected content may be highlighted. For example, the selected content can be highlighted with a border 1230. The driver can easily identify the selected content with the border 1230. In some cases, the selected content may be highlighted for a brief time period before corresponding content is output on the dashboard display. As such, the driver may be able to confirm that his/her intended gaze has been identified by the controller. In some cases, the controller may request the driver to confirm that the highlighted content is correct, for example via voice command or eye movement, is correct prior to outputting the corresponding content on the dashboard display.

As the driver's gaze is moved from the content 1212 to the content 1214, the content displayed on the dashboard display is changed from the content 1222 to the content 1224. In this example, the content 1212 is associated with the content 1222 and the content 1214 is associated with the content 1224.

In some implementations, the controller may output a copied content of the selected content on the dashboard display when or only when a preset movement condition of the gaze is sensed while the selected content has been provided with a border.

For example, when a threshold number of blinks of eyes is sensed, the controller may determine that the preset movement of the gaze has been satisfied. In addition, when the driver's gaze is moved from the display that the border 1230 is displayed to the dashboard display, the controller may determine that the threshold movement of the gaze has been satisfied.

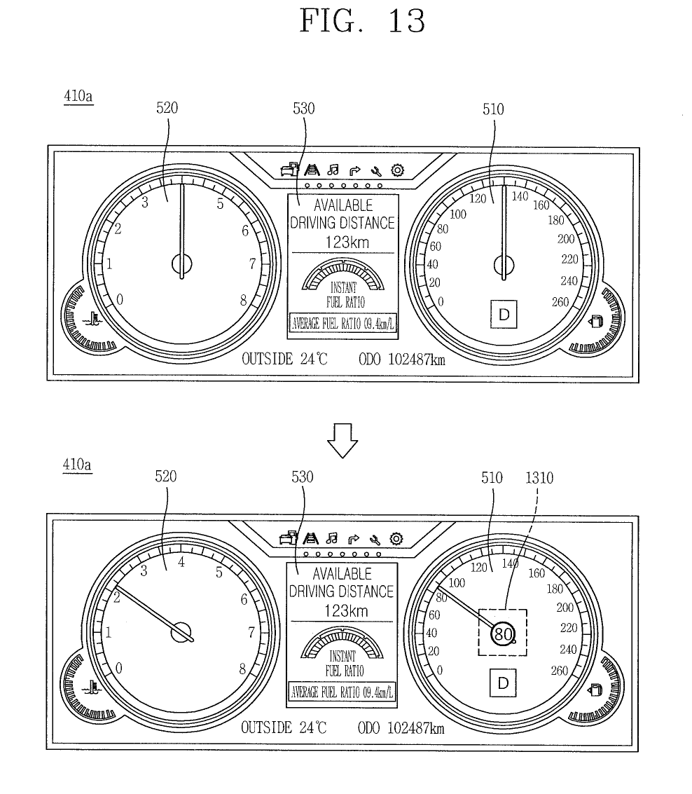

FIG. 13 illustrates an example control device for a vehicle.

When the driver gazes at the dashboard display for a reference time, the controller may control the dashboard display to additionally output a speed limit 1310 of a road at which the vehicle is located.

Information can actively be provided according to the driver's gaze, which may result in increase in the joy of driving and enhancement of the driver's convenience.

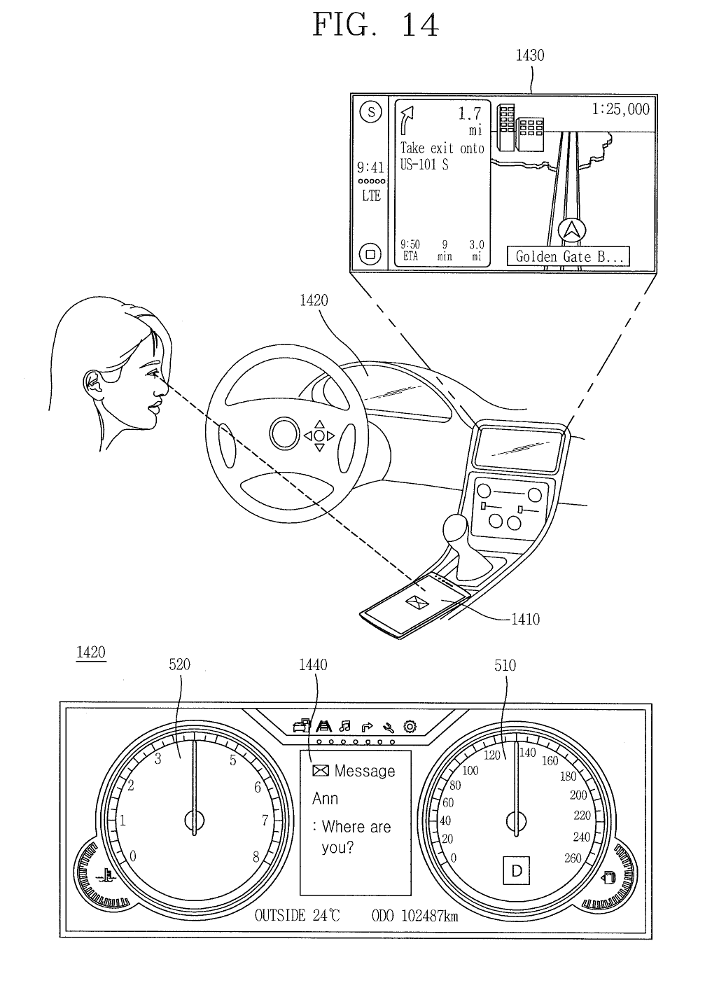

FIG. 14 illustrates an example control device for a vehicle.

A mobile terminal 1410 and the control device for the vehicle may be connected in a wired/wireless manner. The mobile terminal 1410 may transmit an execution screen of an application installed thereon to the control device for the vehicle, and the control device for the vehicle may output the execution screen on at least one display 1430 disposed in the vehicle.

When a message (or email) is received in the mobile terminal 1410, contents of the message may be output on the display 1430 disposed in the vehicle. However, the contents of the message are personal, other passengers except for the driver should not be aware of the contents of the message.

Therefore, the controller may selectively output the contents of the message received in the mobile terminal 1410 on the display 1430 disposed in the vehicle. In particular, when no passenger is present, the contents of the message may be output on the display 1430. When any passenger is present, the contents of the message may be restricted from being output on the display 1430.

In some implementations, when a message is received, a notification signal is output on the mobile terminal 1410 in at least one of visual, audible and tactile manners. When the driver gazes at the mobile terminal 1410 for a reference time, the controller may output the received message on a dashboard display 1420.

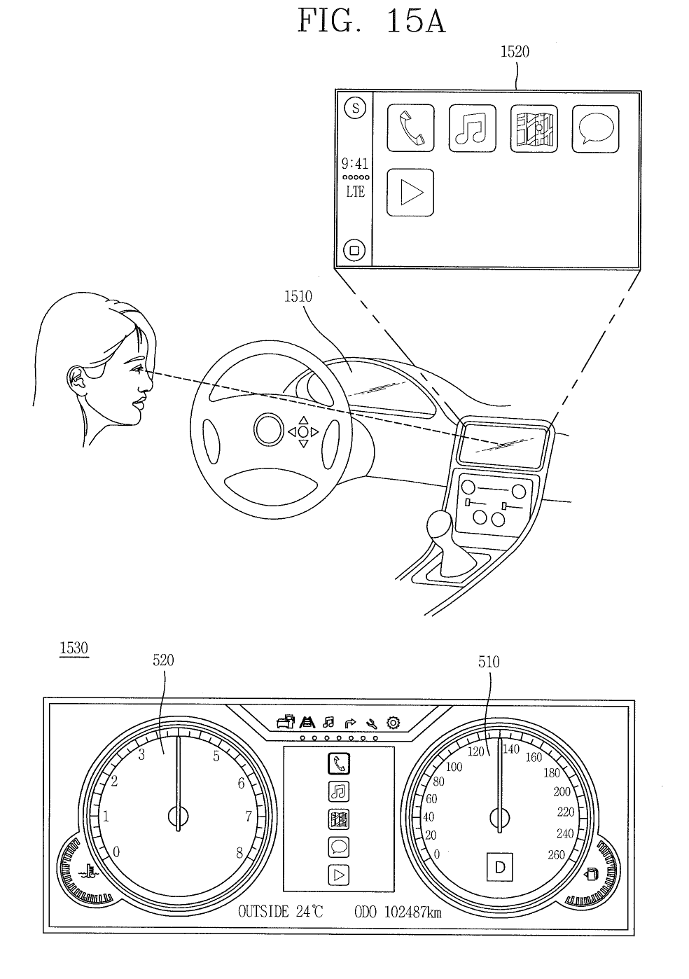

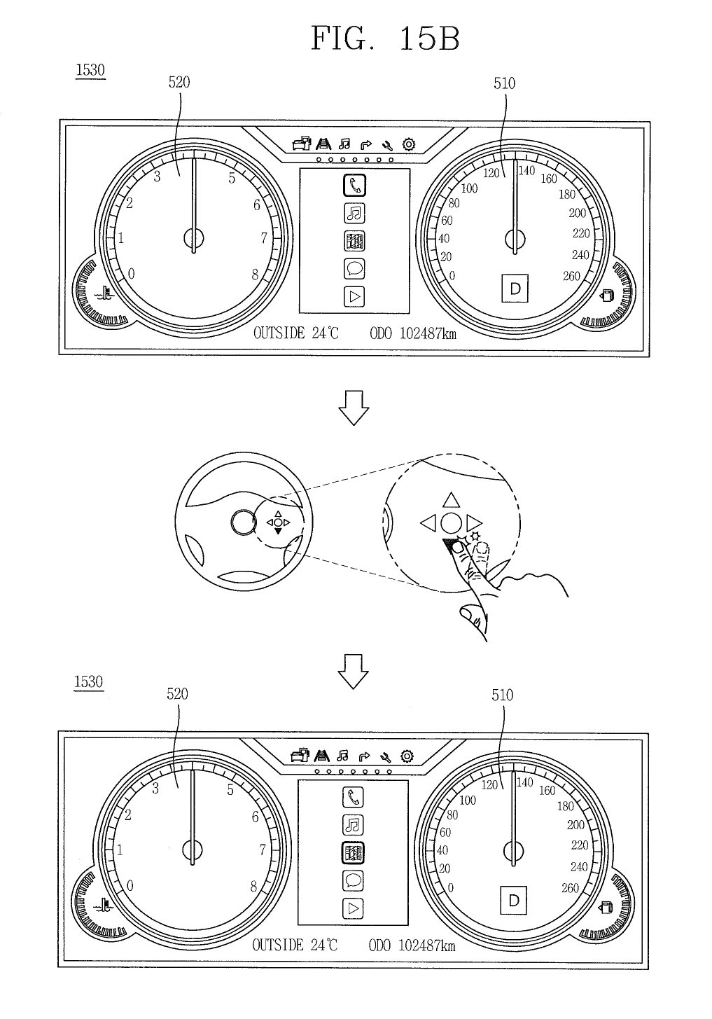

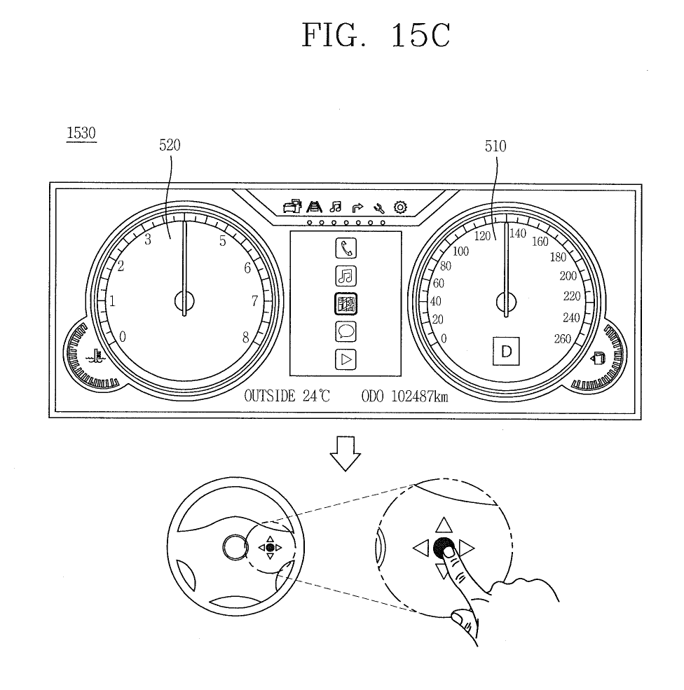

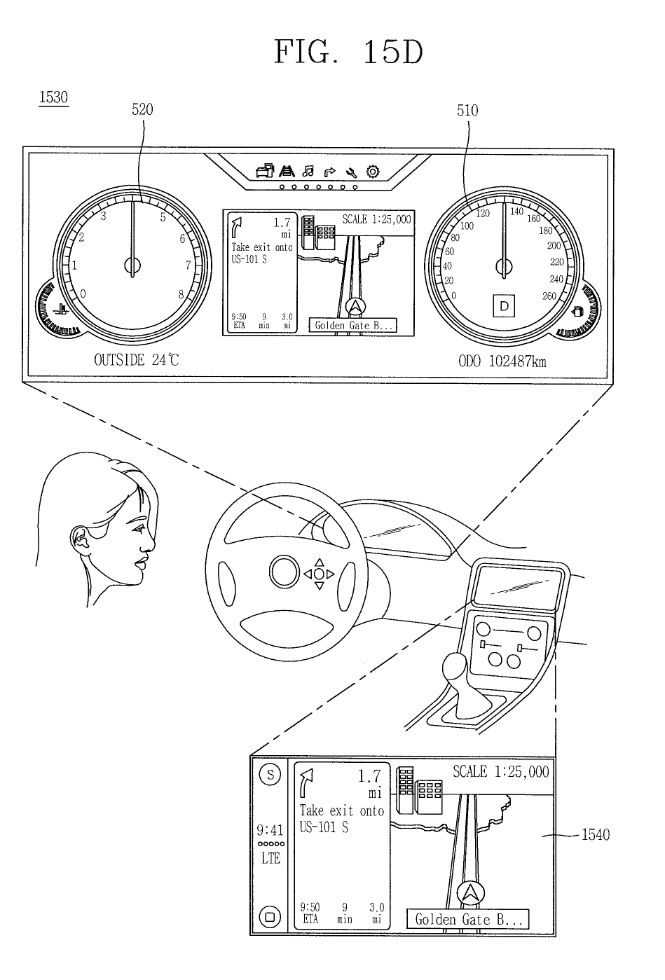

FIGS. 15A to 15D illustrate an example control device for a vehicle.

When a graphic object associated with a control function is output on a display located out of the driver's reach, it is difficult for the driver to touch the graphic object while driving the vehicle.

In some implementations, when the driver's eyes are directed to a particular main graphic object that is displayed on a display 1520, the controller controls to provide a sub graphic object corresponding to the main graphic object to the dashboard display 1510.

The main graphic object and the sub graphic object can be associated with the same control function, e.g., launching a navigation application.

When a user input is applied to the user input unit provided on the steering wheel while the sub graphic object is output on the dashboard display, the controller may execute a control function linked with the sub graphic object.

When the sub graphic object is provided in plurality, the controller may select one of the plurality of sub graphic objects based on the user input, and execute a control function linked with the selected sub graphic object.

For example, as illustrated in FIG. 15A, when the driver gazes a home screen page 1520 for a threshold time while the home screen page 1520 is output, the controller may output at least one sub graphic object corresponding to a main graphic object included in the home screen page 1520 on the dashboard display.

When more than one sub graphic objects are provided, a selected sub graphic object can be highlighted with a border 1530.

As illustrated in FIG. 15B, the user input unit may be provided with navigational (up/down/right/left) buttons and an OK button. As a navigational button is pressed, the selected sub graphic object is changed from one to another, and the border 1530 is also moved.

Afterwards, as illustrated in FIG. 15C, when the OK button is pressed, a control function linked with the corresponding sub graphic object is executed.

As illustrated in FIG. 15D, when a navigation application is executed, a first execution screen may be output on the display 1520, and a second execution screen may be output on the dashboard display 1510.

The driver can execute a function of a graphic object that is output at a distance outer of the driver's reach, even while gripping the steering wheel with both hands.

In some implementations, the controller controls the dashboard display not to output a copied content any more when a predetermined time elapses after the copied content is output on the dashboard display. Selective information which has disappeared due to the copied content is then output on the dashboard display again. This is because a priority of the selective information is higher than that of the copied content.

Also, when the driver's gaze is directed at the dashboard display as many as a predetermined number of times for a predetermined time after a copied content is output on the dashboard display, the controller controls the dashboard display to continuously output the content even after the predetermined time. This is to continuously output the copied content on the dashboard display because the driver frequently uses the copied content.

In some implementations, when the driver's gaze is directed at one display while driving the vehicle, information currently output on the one display may be output on the dashboard display. When the driver's gaze is directed at the one display while the vehicle is stopped, information currently output on the one display may not be output on the dashboard display. The reason of outputting the copied content on the dashboard display is to output information that the driver frequently uses on the dashboard display, so as to enhance the driver's safety. That is, the copied content may be output on the dashboard display only while the vehicle is moving.

In some implementations, the vehicle may be an autonomous vehicle in which some or all operations of the vehicle are carried without active control by the driver. In such vehicles, the vehicle may be switched to the autonomous mode or to the manual mode based on driving environment information, where the driving environment information may include one or more of the following: information on an object outside a vehicle, navigation information, and vehicle state information.

In the manual mode, the vehicle may operate based on user input, such as steering, braking, and acceleration input. In the autonomous mode, the vehicle may operate without user input based on information, data, or signals obtained by a vehicle control system. In some implementations, the autonomous vehicle may include a semi-autonomous mode where some user input may still be required to operate the vehicle. For example, the user may need to occasionally provide steering/braking/acceleration input or attention. Active cruise control, for instance, may be a form of low-level autonomous vehicle control.

In some implementations, restrictions on viewing privileges as described above may be altered depending on the particular level of autonomous driving ability that the vehicle is engaged in or capable of. That is, in a fully autonomous driving mode, the controller may lift some or all restrictions such that the driver may view otherwise restricted displays/objects even while the vehicle is moving. For example, while the vehicle is being driven autonomously without user input, the driver may be allowed to view video content on any of the displays. In some cases, the controller may continue to track the driver's gaze but may not transfer the content to the dashboard display. In partial or phased autonomous driving modes where varying levels of driver input/attention is required, the level of viewing restrictions may depend on the amount of driver input/attention required. For example, the driver may be allowed to view mobile terminal content but may be restricted from viewing video content while the car is moving.

What is claimed is:

1. A control device for a vehicle, the control device comprising:
a plurality of displays including a first display that is configured to provide vehicle information to a driver of the vehicle, the vehicle information including speed information of the vehicle;
a sensor configured to obtain eye tracking information of the driver, the eye tracking information including a gaze of the driver; and
a controller configured to:
determine, based on the eye tracking information, a second display of the plurality of displays to which the gaze of the driver is directed,
select a first content to be displayed on the first display, the first content being based on a gazed second content of the second display, and
provide the first content to the first display to be displayed.

2. The device of claim 1, wherein the gazed second content includes a first visual graphic that is associated with an application, and wherein the controller is configured to, based on determining that gaze of the driver is directed at the second display, display a second visual graphic that is associated with the application on the first display.

3. The device of claim 2, wherein the controller is configured to:
obtain size information of a preset display area of the first display on which the second visual graphic is displayed;
adjust, based on the size information of the preset display area of the first display, a size of the second visual graphic; and
provide the adjusted first visual graphic to the first display to be displayed on the preset display area.

4. The device of claim 3, wherein the first visual graphic of the second display includes a first object, the second visual graphic of the first display includes a second object corresponding to the first object, and a size of the first object is different from a size of the second object.

5. The device of claim 3, wherein the controller is configured to adjust a size of the vehicle information that is displayed on the first display based on the size of the second visual graphic that is displayed on the first display.

6. The device of claim 2, wherein the application is a navigation application, the first visual graphic of the second display includes a first map image, and the second visual graphic of the first display includes a second map image that is at a different map scale than the first map image.

7. The device of claim 1, wherein the controller is configured to determine whether the gazed second content satisfies a preset condition, and to provide, based on the determination that the gazed second content satisfies the preset condition, the first content that is based on the gazed second content to the first display.

8. The device of claim 7, wherein the controller is configured to, based on the determination that the gazed second content does not satisfy the preset condition, provide notification information to at least one of the first display or the second display notifying the driver that the gazed second content is not allowed to be displayed on the first display.

9. The device of claim 1, wherein the controller is configured to determine, based on the eye tracking information of the driver, a partial content among a plurality of contents on the second display to which the gaze of the driver is directed, wherein the first content provided to the first display corresponds to the gazed partial content.

10. The device of claim 9, wherein the controller is configured to determine whether a gaze movement of the tracked eye satisfies a threshold condition, and to provide to the first display the first content corresponding to the gazed partial content based on the determination that the threshold condition has been satisfied.

11. The device of claim 1, wherein the gazed second content includes a primary graphic object that is linked with a preset control function, and wherein the first content provided to the first display is a secondary graphic object that is associated with the primary graphic object, both the primary graphic object and the secondary graphic object being linked with the preset control function.

12. The device of claim 1, wherein the controller is configured to determine whether a time duration that the first content has been displayed on the first display satisfies a threshold time, and to stop displaying, based on the determination that the time duration satisfies the threshold time, the first content to the first display.

13. The device of claim 12, wherein the controller is configured to determine, based on the eye tracking information, whether a number of times that a gaze of the driver has been directed to the first content on the first display satisfies a threshold condition, and to continue displaying the first content to the first display based on (i) the determination that the time duration that the first content has been displayed on the first display satisfies the threshold time and (ii) the determination that the number of times that the gaze of the driver has been directed to the first display satisfies the threshold condition.

14. The device of claim 1, wherein the controller is configured to determine, based on the eye tracking information, whether a gaze of the driver has been maintained for a threshold time on the first display, and to provide, based on the determination that the gaze of the driver has been maintained for the threshold time on the first display, speed limit information of a region where the vehicle is located to be displayed on the first display.

15. The device of claim 1, wherein the controller is configured to provide to be displayed on the first display a plurality of contents to which a gaze of the driver has been directed, the plurality of contents being listed according to an order in which the gaze of the driver was directed to each of the plurality of contents.

16. The device of claim 1, wherein the controller is configured to, based on determining that the gaze of the driver is directed to a third display of the plurality of displays, update the first content to be based on a gazed third content of the third display, and to provide the updated first content to the first display to be displayed.

17. The device of claim 1, wherein the controller is configured to determine whether the vehicle is moving, and to provide, based on the determination that the vehicle is moving, the first content to be displayed on the first display.

18. The device of claim 1, wherein the first display is a dashboard display.

19. A control device for a vehicle, the control device comprising:
a first display that is configured to provide vehicle information to a user inside the vehicle, the vehicle information including speed information of the vehicle;
a sensor configured to obtain eye tracking information of the user inside the vehicle, the eye tracking information including a gaze of the user; and
a controller configured to:
determine, based on the eye tracking information, a target object to which the gaze of the user is directed,
select a first content based on the gazed target object, and
provide the first content on the first display.

20. The device of claim 19, wherein:
the first display is a dashboard display;
the target object is a second display that is separate from the first display; and
the controller is configured to generate the first content based on a second content that is displayed on the second display to be displayed.
